(19) United States
(12) Patent Application Publication
(10) Pub. No.: US 2020/0150625 A1
(43) Pub. Date: May 14, 2020

(54) THREE-DIMENSIONAL OBJECT DATA GENERATION APPARATUS, THREE-DIMENSIONAL OBJECT FORMING APPARATUS, AND NON-TRANSITORY COMPUTER READABLE MEDIUM

(71) Applicant: FUJI XEROX CO., LTD., Tokyo (JP)

(72) Inventors: Yuki YOKOYAMA, Kanagawa (JP); Tomonari TAKAHASHI, Kanagawa (JP); Naoki HIJI, Kanagawa (JP)

(73) Assignee: FUJI XEROX CO., LTD., Tokyo (JP)

(21) Appl. No.: 16/669,535

(22) Filed: Oct. 31, 2019

(30) Foreign Application Priority Data
Nov. 9, 2018 (JP) 2018-211555

(51) Int. Cl. G05B 19/4099; G06T 15/08; G06T 19/20; B29C 64/393; B33Y 50/02

(52) U.S. Cl. CPC G05B 19/4099; G06T 15/08; G06T 19/20; B29C 64/393; G05B 2219/35145; G06T 2219/2016; G05B 2219/35134; G05B 2219/49007; B33Y 50/02

(57) ABSTRACT

A three-dimensional object data generation apparatus includes an obtaining unit that obtains three-dimensional object data representing a three-dimensional object with plural voxels, an attribute pattern reception unit that receives an attribute pattern of an attribute to be set for the plural voxels, a setting condition reception unit that receives a setting condition for setting the attribute for the three-dimensional object in accordance with the attribute pattern, and an attribute setting unit that sets the attribute indicated by the attribute pattern for at least one of the plural voxels in accordance with the setting condition.

### CROSS-REFERENCE TO RELATED APPLICATIONS

This application is based on and claims priority under 35 USC 119 from Japanese Patent Application No. 2018-211555 filed Nov. 9, 2018.

### Background

### (i) Technical Field

The present disclosure relates to a three-dimensional object data generation apparatus, a three-dimensional object forming apparatus, and a non-transitory computer readable medium.

### (ii) Related Art

Japanese Unexamined Patent Application Publication No. 2017-109427 discloses a solid body forming apparatus including a dot forming unit that forms dots included in a solid body to be formed and a support member that supports the solid body and a control unit that controls the forming of the solid body and the support member including the dots. The control unit arranges the dots in a voxel group that represents the support member on the basis of an input value indicating a forming ratio of the dots in voxels included in the voxel group and a dither mask such that a support structure that supports the solid body is formed.

Japanese Unexamined Patent Application Publication No. 2017-30177 discloses a solid body forming apparatus that includes a head unit capable of discharging liquid, a curing unit that forms dots by curing the liquid discharged from the head unit, and a forming control unit that controls operation of the head unit such that a solid body is formed as a group of dots by representing a shape of the solid body to be formed with a voxel group and forming the dots in voxels, in the voxel group, determined by a determination unit as voxels in which the dots are to be formed. The determination unit determines the voxels in which the dots are to be formed in accordance with a forming index, which is a value according to a forming ratio of the dots in voxels in the voxel group inside the solid body and a result of comparison with a threshold included in the dither mask.

Japanese Unexamined Patent Application Publication No. 2018-1725 discloses a three-dimensional data generation apparatus including a measurement result reception unit that receives a result of measurement of a shape of a first object output from an output apparatus using first three-dimensional data specifying the shape of the first object, a correction data calculation unit that calculates correction data on the basis of an error from the shape specified by the first three-dimensional data corresponding to the result of measurement received by the measurement result reception unit, and a data correction unit that corrects second three-dimensional data specifying a shape of a second object using the correction data calculated by the correction data calculation unit.

### SUMMARY

There has been no method for easily setting an attribute, such as material or the like, for a plurality of voxels representing a three-dimensional object. A user undesirably needs to set an attribute for each of a large number of voxels representing a three-dimensional object.

Aspects of non-limiting embodiments of the present disclosure relate to a three-dimensional object data generation apparatus, a three-dimensional object forming apparatus, and a non-transitory computer readable medium capable of efficiently setting an attribute for voxels compared to when a user sets an attribute for each of voxels.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a three-dimensional object data generation apparatus including an obtaining unit that obtains three-dimensional object data representing a three-dimensional object with a plurality of voxels, an attribute pattern reception unit that receives an attribute pattern of an attribute to be set for the plurality of voxels, a setting condition reception unit that receives a setting condition for setting the attribute for the three-dimensional object in accordance with the attribute pattern, and an attribute setting unit that sets the attribute indicated by the attribute pattern for at least one of the plurality of voxels in accordance with the setting condition.

### BRIEF DESCRIPTION OF THE DRAWINGS

An exemplary embodiment of the present disclosure will be described in detail based on the following figures, wherein:

FIG. 1 is a diagram illustrating the configuration of a three-dimensional object forming system;

FIG. 2 is a diagram illustrating the configuration of a three-dimensional object data generation apparatus;

FIG. 3 is a block diagram illustrating the functional configuration of the three-dimensional object data generation apparatus;

FIG. 4 is a diagram illustrating an example of a three-dimensional object represented by voxel data;

FIG. 5 is a diagram illustrating the configuration of a three-dimensional object forming apparatus;

FIG. 6 is a flowchart illustrating a process achieved by a program for generating three-dimensional object data;

FIG. 7 is a diagram illustrating an example of a three-dimensional object;

FIG. 8 is a diagram illustrating an example of an attribute registration screen;

FIG. 9 is a diagram illustrating an example of an image as an attribute pattern;

FIG. 10 is a diagram illustrating setting of an initial position of an image;

FIG. 11 is a diagram illustrating conversion of resolution;

FIG. 12 is a diagram illustrating an example of an editing process;

FIG. 13 is a diagram illustrating another example of the editing process;

FIG. 14 is a diagram illustrating setting of an attribute;

FIG. 15 is a diagram illustrating setting of an attribute;

FIG. 16 is a diagram illustrating an example of an image as an attribute pattern;

FIG. 17 is a diagram illustrating setting of an attribute;

FIG. 18 is a diagram illustrating setting of an attribute;

FIG. 19 is a diagram illustrating a case where a plurality of attribute patterns have been received;

FIG. 20 a diagram illustrating the case where a plurality of attribute patterns have been received;

FIG. 21 a diagram illustrating the case where a plurality of attribute patterns have been received;

FIG. 22 is a diagram illustrating a case where an attribute pattern is a three-dimensional image; and

FIG. 23 is a diagram illustrating the case where an attribute pattern is a three-dimensional image.

### DETAILED DESCRIPTION

An exemplary embodiment of the present disclosure will be described hereinafter with reference to the drawings.

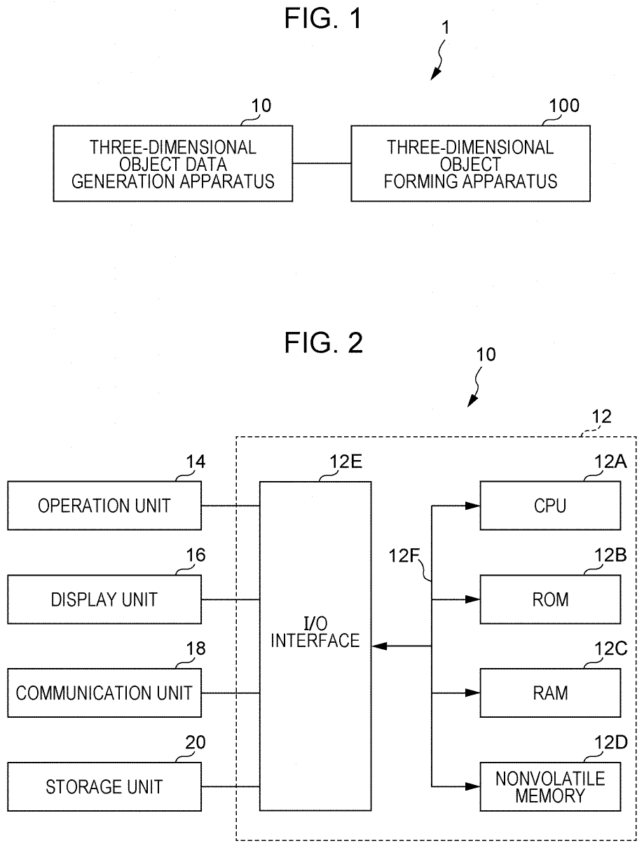

FIG. 1 is a diagram illustrating the configuration of a three-dimensional object forming system 1 according to the present exemplary embodiment. As illustrated in FIG. 1, the three-dimensional object forming system 1 includes a three-dimensional object data generation apparatus 10 and a three-dimensional object forming apparatus 100.

Next, the configuration of the three-dimensional object data generation apparatus 10 according to the present exemplary embodiment will be described with reference to FIG.

2.

The three-dimensional object data generation apparatus 10 is a personal computer, for example, and includes a controller 12. The controller 12 includes a central processing unit (CPU) 12A, a read-only memory (ROM) 12B, a random-access memory (RAM) 12C, a nonvolatile memory 12D, and an input/output (I/O) interface 12E. The CPU 12A, the ROM 12B, the RAM 12C, the nonvolatile memory 12D, and the I/O interface 12E are connected to one another through a bus 12F.

An operation unit 14, a display unit 16, a communication unit 18, and a storage unit 20 are connected to the I/O interface 12E.

The operation unit 14 includes, for example, a mouse and a keyboard.

The display unit 16 is, for example, a liquid crystal display.

The communication unit 18 is an interface for communicating data with external apparatuses such as the three-dimensional object forming apparatus 100.

The storage unit 20 is a nonvolatile storage device such as a hard disk and stores a program for generating three-dimensional object data, which will be described later, three-dimensional object data (voxel data), and three-dimensional threshold matrices, and the like. The CPU 12A reads the program for generating three-dimensional object data stored in the storage unit 20 and executes the program.

Next, the functional configuration of the CPU 12A will be described.

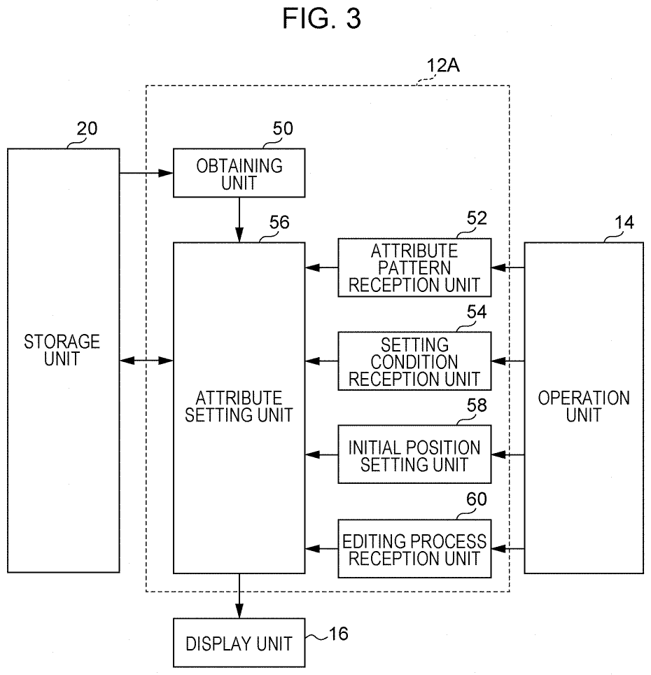

As illustrated in FIG. 3, the CPU 12A includes an obtaining unit 50, an attribute pattern reception unit 52, a setting condition reception unit 54, an attribute setting unit 56, an initial position setting unit 58, and an editing process reception unit 60 in terms of functions.

The obtaining unit 50 obtains three-dimensional object data representing a three-dimensional object with a plurality of voxels by reading the three-dimensional object data from the storage unit 20.

The attribute pattern reception unit 52 receives an attribute pattern of an attribute to be set for voxels. The attribute includes at least one attribute indicating a property of each voxel, such as color, intensity, material, or texture. Types of attribute, however, are not limited to these.

The setting condition reception unit 54 receives a setting condition for setting an attribute for a three-dimensional object in accordance with an attribute pattern received by the attribute pattern reception unit 52. In the present exemplary embodiment, a projection line is received as an example of the setting condition.

The attribute setting unit 56 sets an attribute indicated by an attribute pattern for at least one of a plurality of voxels in accordance with a setting condition received by the setting condition reception unit 54.

The initial position setting unit 58 sets an initial position of an attribute pattern relative to a three-dimensional object. For example, the user may specify the initial position, or the initial position may be automatically set so that a predetermined condition is satisfied.

The editing process reception unit 60 receives at least movement, rotation, enlargement, or reduction as a process for editing an attribute pattern.

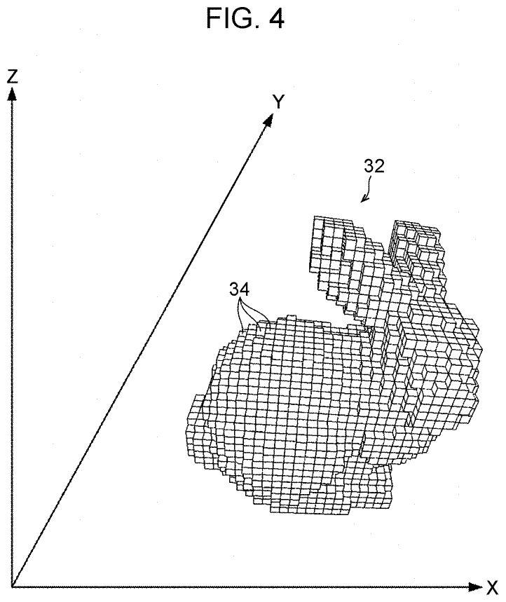

FIG. 4 illustrates a three-dimensional object 32 represented by three-dimensional object data (voxel data), which is a group of voxels. As illustrated in FIG. 4, the three-dimensional object 32 includes a plurality of voxels 34.

The voxels 34 are basic elements of the three-dimensional object 32. The voxels 34 may be rectangular parallelepipeds, for example, but may be spheres or cylinders, instead. A desired three-dimensional object is represented by stacking the voxels 34 on one another.

As a method for forming a three-dimensional object, for example, fused deposition modeling (FDM), in which a thermoplastic resin is plasticized and stacked to form a three-dimensional object, or selective laser sintering (SLS), in which a laser beam is radiated onto a powdery metal material to form a three-dimensional object through sintering, is used, but another method may be used, instead. In the present exemplary embodiment, a case where a three-dimensional object is formed using FDM will be described.

Next, a three-dimensional object forming apparatus that forms a three-dimensional object using three-dimensional object data generated by the three-dimensional object data generation apparatus 10 will be described.

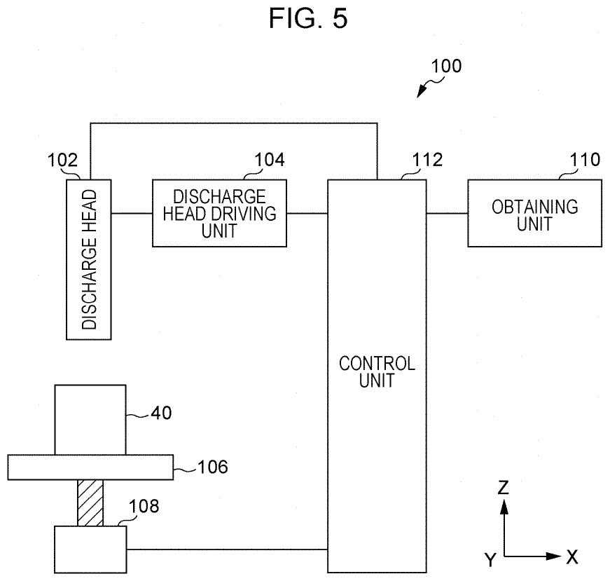

FIG. 5 illustrates the configuration of the three-dimensional object forming apparatus 100 according to the present exemplary embodiment. The three-dimensional object forming apparatus 100 forms a three-dimensional object using FDM.

As illustrated in FIG. 5, the three-dimensional object forming apparatus 100 includes a discharge head 102, a discharge head driving unit 104, a stand 106, a stand driving unit 108, an obtaining unit 110, and a control unit 112. The discharge head 102, the discharge head driving unit 104, the stand 106, and the stand driving unit 108 are an example of a forming unit.

The discharge head 102 includes an object material discharge head that discharges an object material for forming a three-dimensional object 40 and a support material discharge head that discharges a support material. The support material is used to support overhangs (also referred to as “projections”) of the three-dimensional object 40 and removed after the three-dimensional object 40 is formed.

The discharge head 102 is driven by the discharge head driving unit 104 and moves on an X-Y plane in two dimensions. The object material discharge head may include a plurality of discharge heads corresponding to object materials of a plurality of attributes (e.g., colors).

The stand 106 is driven by the stand driving unit 108 and moves along a Z axis.

The obtaining unit 110 obtains three-dimensional object data and support material data generated by the three-dimensional object data generation apparatus 10.

The control unit 112 drives the discharge head driving unit 104 to move the discharge head 102 in two dimensions and controls the discharge of the object material and the support material performed by the discharge head 102 such that the object material is discharged in accordance with the three-dimensional object data obtained by the obtaining unit 110 and the support material is discharged in accordance with the support material data obtained by the obtaining unit 110.

Each time a layer has been formed, the control unit 112 drives the stand driving unit 108 to lower the stand 106 by a predetermined layer interval. As a result, a three-dimensional object based on three-dimensional object data is formed.

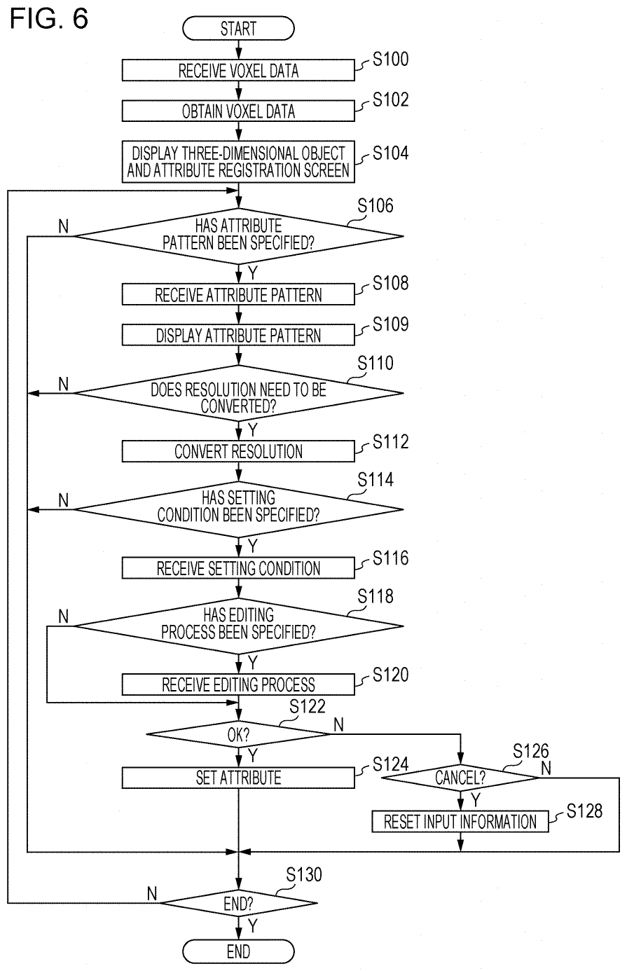

Next, the operation of the three-dimensional object data generation apparatus 10 according to the present exemplary embodiment will be described with reference to FIG. 6. A generation process illustrated in FIG. 6 is performed by causing the CPU 12A to execute a program for generating three-dimensional object data. The generation process illustrated in FIG. 6 is performed, for example, when the user has requested execution of the program. In the present exemplary embodiment, description of a process for generating support material data is omitted.

In step S100, voxel data corresponding to a three-dimensional object to be formed is received. For example, a screen for receiving voxel data is displayed on the display unit 16 through a user operation, and voxel data specified by the user is received.

In step S102, the voxel data received in step S100 is read, for example, from the storage unit 20. Alternatively, the voxel data may be obtained from an external apparatus through the communication unit 18.

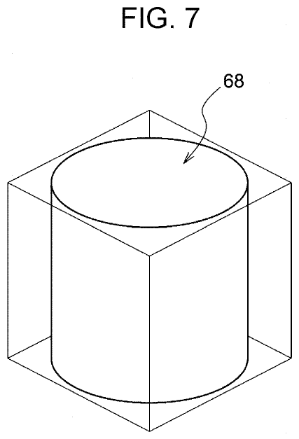

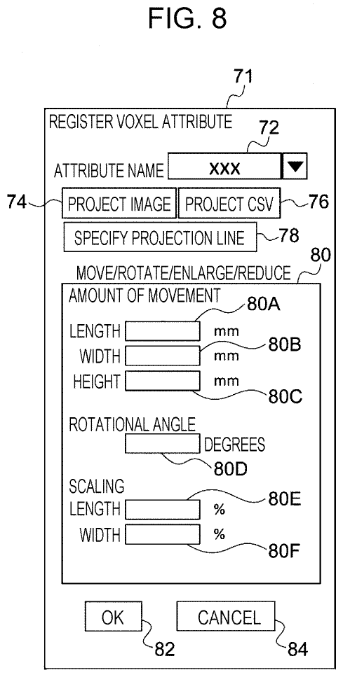

In step S104, display data regarding the three-dimensional object is generated from the voxel data obtained in step S102 and displayed on the display unit 16. In the present exemplary embodiment, a case where the three-dimensional object is a cylindrical three-dimensional object 68 illustrated in FIG. 7 will be described. An attribute registration screen 71 illustrated in FIG. 8, for example, is also displayed on the display unit 16. For example, the three-dimensional object 68 is displayed in a left part of the display unit 16, and the attribute registration screen 71 is displayed in a right part of the display unit 16.

As illustrated in FIG. 8, the attribute registration screen 71 includes an attribute name input field 72 for inputting an attribute name, an image specification button 74 for specifying image data, a comma-separated values (CSV) specification button 76 for specifying CSV data, a projection line specification button 78 for specifying a projection line, an editing parameter input field 80 for inputting editing parameters at a time when an attribute pattern represented by an image file or a CSV file is edited, an OK button 82 for registering an attribute, and a cancel button 84 for canceling registration of an attribute.

The editing parameter input field 80 includes input fields 80A to 80C for inputting the amount of movement in length, width, and height directions, that is, X-axis, Y-axis, 3 and Z-axis directions, of an attribute pattern, an input field 80D for inputting a rotational angle of the attribute pattern, and input fields 80E and 80F for inputting scaling in the length and width directions, that is, the X-axis and Y-axis directions, of the attribute pattern.

The user inputs a desired attribute name in the attribute name input field 72.

An attribute pattern includes a plurality of elements representing two-dimensional object data. In the present exemplary embodiment, a case where the attribute pattern is image data or CSV data will be described. When the attribute pattern is image data, the elements are pixel values of pixels. When the attribute pattern is CSV data, the elements are values separated by commas. The CSV data is data in which a plurality of values are separated by commas.

In step S106, whether an attribute pattern has been specified is determined. That is, whether the image specification button 74 or the CSV specification button 76 has been selected through a user operation is determined. If the image specification button 74 or the CSV specification button 76 has been selected, the process proceeds to step S108. If neither the image specification button 74 nor the CSV specification button 76 has been selected, the process proceeds to step S130.

In step S108, an attribute pattern corresponding to the button selected in step S106 is received. More specifically, if the user has clicked the image specification button 74, a screen including a list of image data stored in the storage unit 20 is displayed on the display unit 16. If the user selects a desired piece of image data on the screen, the selected piece of image data is read from the storage unit 20.

If the user has clicked the CSV specification button 76, on the other hand, a screen including a list of CSV data stored in the storage unit 20 is displayed on the display unit 16. If the user selects a desired piece of CSV data on the screen, the selected piece of CSV data is read from the storage unit 20.

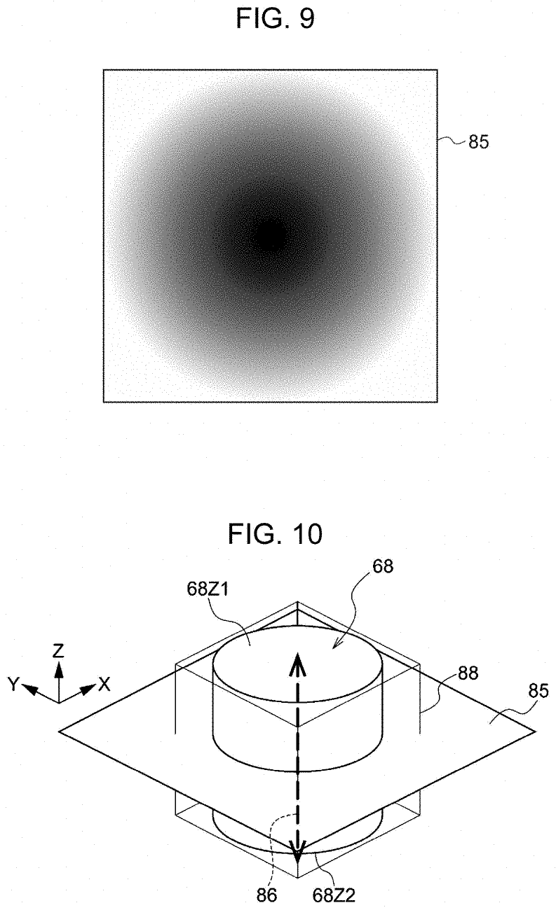

In the present exemplary embodiment, a case where the attribute pattern received in step S108 is an image 85 illustrated in FIG. 9 will be described.

In step S109, the attribute pattern received in step S108 is displayed on the display unit 16. As illustrated in FIG. 10, for example, the image 85, which is the attribute pattern received in step S108, is displayed for the three-dimensional object 68 at a predetermined initial position, namely, for example, at the center of a screen.

In step S110, whether at least either the resolution of the attribute pattern received in step S108 or the resolution of voxels corresponding to the voxel data obtained in step S102 needs to be converted is determined. Information regarding the resolution is included in the image data or the CSV data.

More specifically, first, it is determined whether the user has specified a resolution. Although not illustrated, the user may specify, on a screen for specifying a resolution, a third resolution that is different from the resolution of the attribute pattern received in step S108 and the resolution of the voxels corresponding to the voxel data obtained in step S102.

If the user has specified a resolution, the process proceeds to step S112. If the user has not specified a resolution, on the other hand, whether the resolution of the attribute pattern received in step S108 and the resolution of the voxels corresponding to the voxel data obtained in step S102 are different from each other is determined. If so, the process proceeds to step S112, and if not, the process proceeds to step S130.

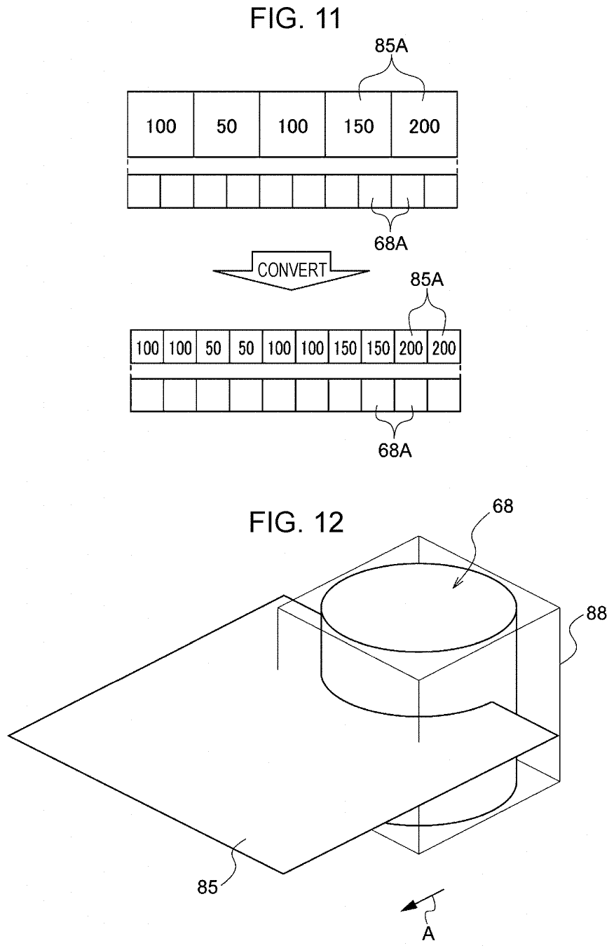

In step S112, at least the resolution of the attribute pattern or the resolution of the voxels is converted such that the resolution of the attribute pattern and the resolution of the voxels match. A case will be described where the user has not specified a resolution and the resolution of the attribute pattern received in step S108 and the resolution of the voxels corresponding to the voxel data obtained in step S102 are different from each other. More specifically, as illustrated in FIG. 11, for example, a case will be described where the pixel pitch, that is, the resolution, of pixels 85A of the image 85 is half the pixel pitch, that is, the resolution, of voxels 68A representing the three-dimensional object 68. In this case, the resolution of the pixels 85A is doubled, that is, the pixel pitch of the pixels 85A is halved, so that the resolution of the image 85 and the resolution of the voxels 68A match. Alternatively, the resolution of the voxels 68A may be halved, that is, the voxel pitch of the voxels 68A may be doubled, so that the resolution of the image 85 and the resolution of the voxels 68A match. If the user has specified a third resolution that is different from the resolution of the image 85 and the resolution of the voxels 68A, both the resolution of the image 85 and the resolution of the voxels 68A are converted such that the resolution of the image 85 and the resolution of the voxels 68A match the specified resolution.

In step S114, whether a projection line has been specified as a setting condition is determined. That is, whether the user has selected the projection line specification button 78 is determined. If so, the process proceeds to step S116, and if not, the process proceeds to step S130.

In step S116, the projection line specified by the user is received with the three-dimensional object 68 displayed. As illustrated in FIG. 10, for example, the user specifies a projection line 86, which indicates a direction in which the attribute is to be set, using a mouse of the operation unit 14 or the like. More specifically, the user specifies a direction and a length of the projection line 86. In the example illustrated in FIG. 10, the projection line 86 is set in the Z-axis direction and long enough to penetrate a top surface 68Z1 and a bottom surface 68Z2 of the three-dimensional object 68. The length of the projection line 86 is not limited to this, and may be set in accordance with the size of an area in which the attribute is to be set.

As illustrated in FIG. 10, a bounding box 88 containing the three-dimensional object 68 may be set, and a line connecting a top surface and a bottom surface of the bounding box 88 may be set as a projection line, instead.

The projection line need not be a straight line. The projection line may be a curve or a bent line, instead. The projection line need not be a continuous line, and may be a discontinuous line, instead.

In step S118, whether at least movement, rotation, enlargement, or reduction has been specified as a process for editing an attribute pattern is determined. If so, the process proceeds to step S120, and if not, the process proceeds to step S122.

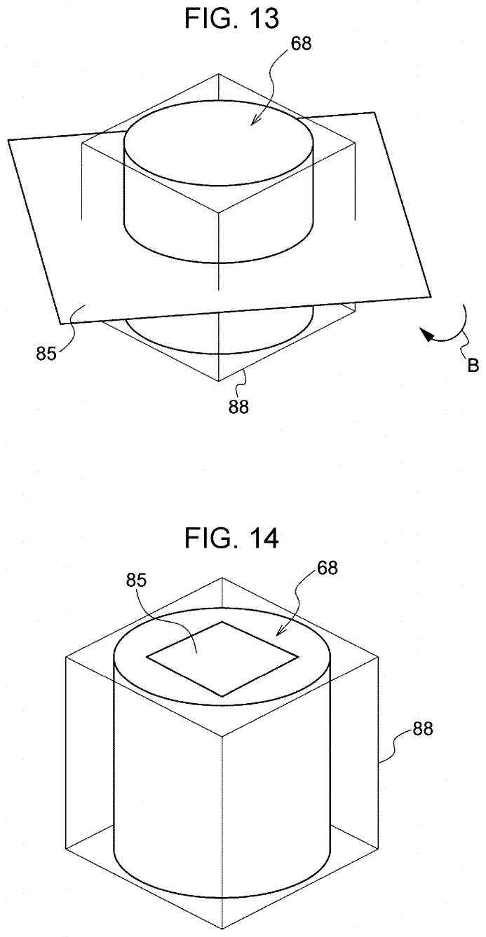

In step S120, the editing process specified by the user is received. The user specifies at least movement, rotation, enlargement, or reduction as an editing process by operating the operation unit 14. For example, the image 85 is moved from a position illustrated in FIG. 10 in a direction of an arrow A illustrated in FIG. 12. In other cases, the image 85 is rotated at the position illustrated in FIG. 10 in a direction of an arrow B illustrated in FIG. 13 or reduced from a size illustrated in FIG. 10 to a size illustrated in FIG. 14.

The user may directly specify an editing process for the three-dimensional object 68 and the image 85 displayed on the display unit 16 by operating the mouse of the operation unit 14 or the like. Alternatively, the user may specify an editing process by inputting a value in the editing parameter input field 80. If the user inputs a value in the editing parameter input field 80, the image 85 is edited in accordance with the input value.

An initial position of the image 85 is thus set as the user specifies a positional relationship between the three-dimensional object 68 and the image 85. Alternatively, the initial position of the image 85 may be automatically set so that a predetermined condition is satisfied. For example, the initial position of the image 85 may be calculated such that the center of gravity of the image 85 and the center of gravity of the three-dimensional object 68 match. Alternatively, when an attribute is set by copying pixel values of the image 85 along the projection line 86, a position at which the number of attributes set is largest may be calculated and set as the initial position of the image 85. The image 85 may be enlarged or reduced such that the size of the image 85 and the size of the three-dimensional object 68 match.

In step S122, whether the OK button 82 has been selected is determined. If so, the process proceeds to step S124, and if not, the process proceeds to step S126.

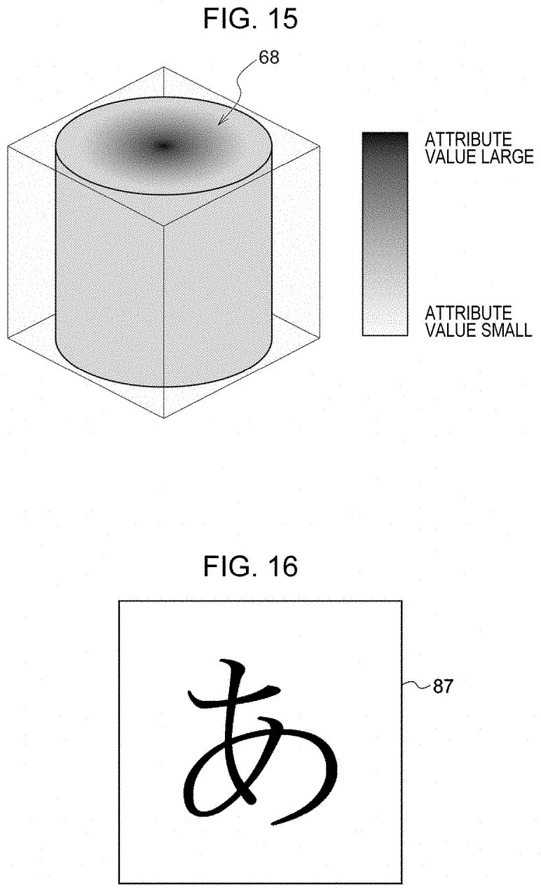

In step S124, the attribute indicated by the attribute pattern is set for at least one of the plurality of voxels in accordance with the setting condition received in step S116. As a result, three-dimensional object data in which the attribute is set for each voxel is generated. In the example illustrated in FIG. 10, the pixel values of the pixels 85A of the image 85 are set as the attribute for the voxels 68A of the three-dimensional object 68 in accordance with the projection line 86. As a result, as illustrated in FIG. 15, for example, the pixel values of the pixels 85A of the image 85 are set as the attribute for the voxels 68A of the cylindrical three-dimensional object 68. In the example illustrated in FIG. 15, darker parts indicate higher attribute values and paler parts indicate lower attribute values.

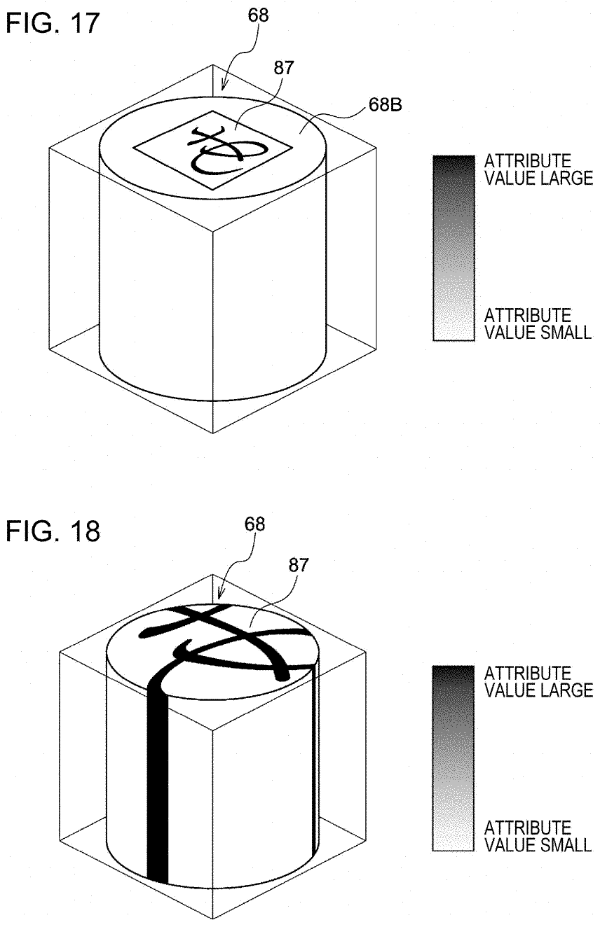

An attribute need not be set or a predetermined value may be set for a part of a three-dimensional object outside an attribute pattern. It is assumed, for example, that the three-dimensional object 68 is larger than an image 87, which is an attribute pattern, illustrated in FIG. 16. In this case, as illustrated in FIG. 17, an attribute need not be set or a predetermined value, namely 0, for example, may be set for a part 68B of the three-dimensional object 68 outside the image 86.

If an attribute pattern is larger than a three-dimensional image, for example, an attribute need not be set for a part of the attribute pattern outside the three-dimensional image. It is assumed, for example, that an image 87 is larger than the three-dimensional object 68 as illustrated in FIG. 18. In this case, as illustrated in FIG. 18, an attribute need not be set for a part of the image 87 outside the three-dimensional object 68, and no changes are caused before and after the setting of the attribute.

In step S126, on the other hand, whether the cancel button 84 has been selected is determined. If so, the process proceeds to step S128, and if not, the process proceeds to step S130.

In step S128, the information input on the attribute registration screen 71 is reset.

In step S130, whether to end the routine is determined. Whether to end the routine is determined, for example, by determining whether an operation for closing the screen has been performed. If so, the routine ends, and if not, the process returns to step S106.

In the present exemplary embodiment, an attribute pattern and a setting condition are received, and an attribute indicated by the attribute pattern is set for at least one of a plurality of voxels in accordance with the setting condition. The user therefore need not set the attribute for each of voxels.

Next, a case will be described where a three-dimensional object is formed on the basis of three-dimensional object data generated by the three-dimensional object data generation apparatus 10.

The obtaining unit 110 of the three-dimensional object forming apparatus 100 obtains the voxel data transmitted from the three-dimensional object data generation apparatus 10. The control unit 112 drives the discharge head driving unit 104 to move the discharge head 102 in two dimensions and control discharging of an object material by the discharge head 102 such that the object material is discharged in accordance with the voxel data obtained by the obtaining unit 110. As a result, a three-dimensional object is formed.

Although the present disclosure has been described using an exemplary embodiment, the present disclosure is not limited to the above exemplary embodiment. The exemplary embodiment may be modified or improved in various ways without deviating from the scope of the present disclosure. The technical scope of the present disclosure also includes such modifications and improvements.

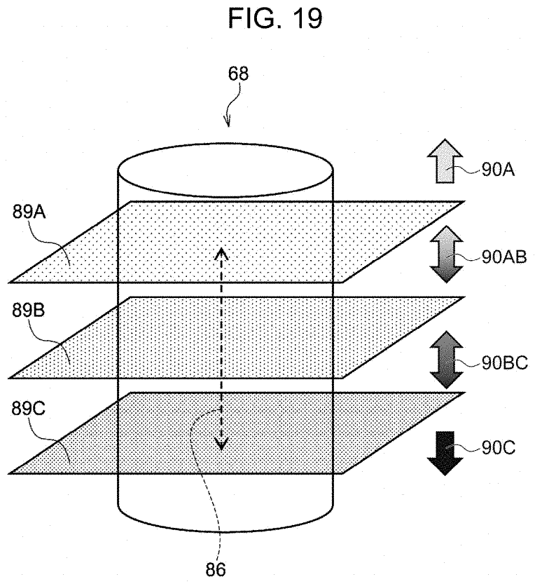

Although only one attribute pattern is received in the present exemplary embodiment, a plurality of attribute patterns may be received in steps S106 and S108, instead. In this case, an attribute of adjacent attribute patterns may be set such that the attribute gradually changes between the attribute patterns. It is assumed, for example, that a plurality of images 89A to 89C have been received as illustrated in FIG. 19.

In this case, pixel values of pixels of the image 89A are copied as an attribute for voxels of the three-dimensional object 68 located higher than the image 89A in a direction of the projection line 86, that is, voxels in an area 90A. Pixel values of pixels of the image 89C are copied as the attribute for voxels of the three-dimensional object 68 located lower than the image 89C in the direction of the projection line 86, that is, voxels in an area 90C. For voxels in an area 90AB located between the images 89A and 89B, the attribute is set such that the pixel values of the pixels of the image 89A gradually change to pixel values of pixels of the image 89B. Similarly, for voxels in an area 90BC located between the images 89B and 89C, the attribute is set such that the pixel values of the pixels of the image 89B gradually change to the pixel values of the pixels of the image 89C.

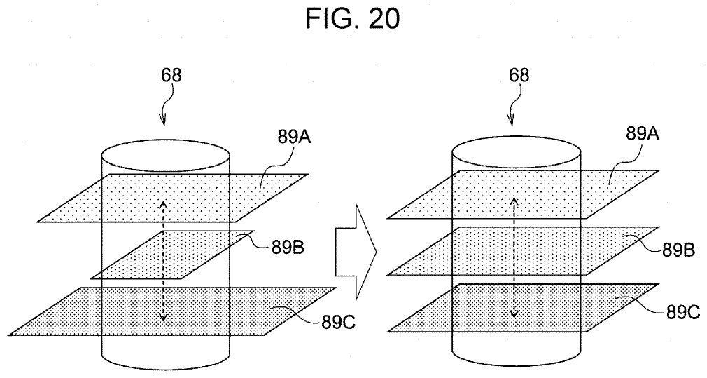

If at least either sizes or resolutions of a plurality of attribute patterns are different from each other, at least one of the sizes or the resolutions of the plurality of attribute patterns may be converted such that the sizes or the resolutions of the plurality of attribute patterns match. If sizes of the images 89A to 89C are different from one another as illustrated in FIG. 20, for example, the image 89B may be enlarged and the image 89C may be reduced so that the sizes of the images 89A to 89C match. Alternatively, the image 89B need not be enlarged, but the attribute at an edge of the image 89B may be copied to a position corresponding to an edge of the image 89A. Alternatively, the image 89C need not be reduced, but the attribute outside an edge of the image 89C corresponding to the edge of the image 89A may be removed.

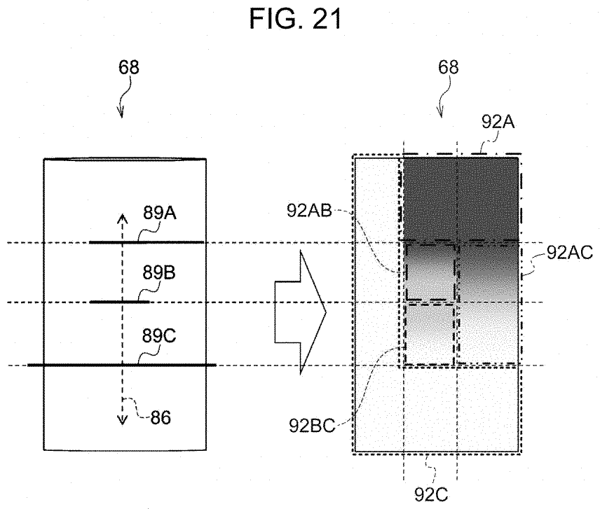

Even when at least either sizes or resolutions of a plurality of attribute patterns are different from each other, the sizes or the resolutions of the plurality of attribute patterns need not matched. That is, an attribute of voxels in an area between adjacent images in a direction of a projection line may be set such that the attribute gradually changes, and the attribute may be copied for voxels in an area for which no adjacent image exists in the direction of the projection line. As illustrated in FIG. 21, for example, an attribute of voxels in an area 92AB between the images 89A and 89B in the direction of the projection line 86 is set such that the attribute gradually change from the pixel values in the image 89A to the pixel values in the image 89B. The attribute of voxels in an area 92BC between the images 89B and 89C in the direction of the projection line 86 is set such that the attribute gradually changes from the pixel values in the image 89B to the pixel values in the image 89C. The attribute of voxels in an area 92AC between the images 89A and 89C in the direction of the projection line 86 is set such that the attribute gradually changes from the pixel values in the image 89A to the pixel values in the image 89C.

For voxels in an area 92A, for which no image adjacent to the image 89A exists in the direction of the projection line 86, on the other hand, the pixel values in the image 89A may be copied. Similarly, for voxels in an area 92C, for which no image adjacent to the image 89C exists in the direction of the projection line 86, the pixel values in the image 89C may be copied.

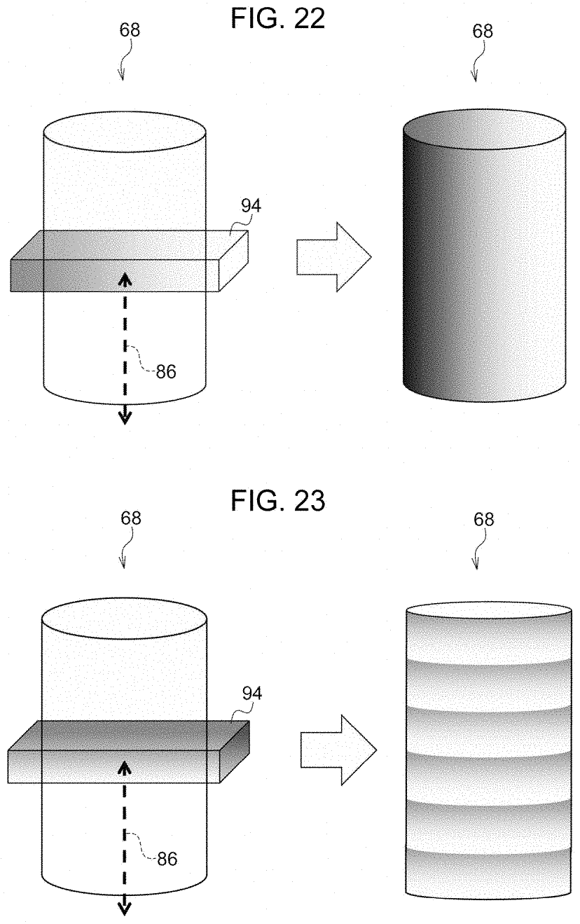

An attribute may be set using an attribute pattern including three-dimensional information, such as image data regarding images on a plurality of pages, image data regarding images in a plurality of layers, or CSV data including three-dimensional information, instead. In this case, the attribute may be set by enlarging or reducing a three-dimensional image in accordance with a size or a position of a three-dimensional object and copying pixel values of the image along a projection line. If the attribute pattern is a three-dimensional image 94 and the projection line 86 is set as illustrated in FIG. 22, for example, an attribute may be set by reducing the three-dimensional image 94 in accordance with the width of the three-dimensional object 68 and copying pixel values in the image 94 along the projection line 86. Alternatively, the attribute may be set by performing extrapolation or removal on a three-dimensional image along a projection line. If the three-dimensional image 94 protrudes from the three-dimensional object 68 as illustrated in FIG. 22, for example, protrusions may be removed. If a three-dimensional object protrudes from a three-dimensional image, on the other hand, the attribute may be set by performing extrapolation for protrusions.

An attribute may be set by repeatedly arranging a three-dimensional image along a projection line, instead. As illustrated in FIG. 23, for example, the three-dimensional image 94 may be reduced in accordance with the size of the three-dimensional object 68 and repeatedly copied along the projection line 86 to set an attribute.

Although the three-dimensional object data generation apparatus 10 and the three-dimensional object forming apparatus 100 that forms a three-dimensional object on the basis of three-dimensional object data are separately provided in the above exemplary embodiment, the three-dimensional object forming apparatus 100 may have the function of the three-dimensional object data generation apparatus 10, instead.

That is, the obtaining unit 110 of the three-dimensional object forming apparatus 100 may obtain voxel data, and the control unit 112 may generate three-dimensional object data by performing the generation process illustrated in FIG. 6.

Alternatively, for example, the process for generating three-dimensional object data illustrated in FIG. 6 may be achieved by hardware such as an application-specific integrated circuit (ASIC). In this case, processing speed increases compared to when the process is achieved by software.

Although the program for generating three-dimensional object data is installed on the storage unit 20 in the above exemplary embodiment, the process need not be installed on the storage unit 20. The program according to the above exemplary embodiment may be provided in a computer readable storage medium, instead. For example, the program in the present disclosure may be provided in an optical disc such as a compact disc read-only memory (CD-ROM) or a digital versatile disc read-only memory (DVD-ROM) or a semiconductor memory such as a universal serial bus (USB) memory or a memory card. Alternatively, the program according to the above exemplary embodiment may be obtained from an external apparatus through a communication line connected to the communication unit 18.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A three-dimensional object data generation apparatus comprising:
an obtaining unit that obtains three-dimensional object data representing a three-dimensional object with a plurality of voxels;
an attribute pattern reception unit that receives an attribute pattern of an attribute to be set for the plurality of voxels;
a setting condition reception unit that receives a setting condition for setting the attribute for the three-dimensional object in accordance with the attribute pattern; and
an attribute setting unit that sets the attribute indicated by the attribute pattern for at least one of the plurality of voxels in accordance with the setting condition.

2. The three-dimensional object data generation apparatus according to claim 1, further comprising:
an initial position setting unit that sets an initial position of the attribute pattern relative to the three-dimensional object.

3. The three-dimensional object data generation apparatus according to claim 2,
wherein the initial position setting unit sets the initial position so as to satisfy a predetermined condition.

4. The three-dimensional object data generation apparatus according to claim 2,
wherein the initial position setting unit sets the initial position in accordance with specification performed by a user.

5. The three-dimensional object data generation apparatus according to claim 1, further comprising:
an editing process reception unit that receives at least one of movement, rotation, enlargement, and reduction as a process for editing the attribute pattern.

6. The three-dimensional object data generation apparatus according to claim 1,
wherein, if a resolution of the attribute pattern and a resolution of the plurality of voxels are different from each other, the attribute setting unit converts at least either the resolution of the attribute pattern or the resolution of the plurality of voxels such that the resolution of the attribute pattern and the resolution of the plurality of voxels match.

7. The three-dimensional object data generation apparatus according to claim 1,
wherein the attribute pattern is one of a plurality of attribute patterns, and
wherein the attribute pattern reception unit receives the plurality of attribute patterns.

8. The three-dimensional object data generation apparatus according to claim 7,
wherein the attribute setting unit sets an attribute of adjacent attribute patterns such that the attribute gradually changes between the plurality of attribute patterns.

9. The three-dimensional object data generation apparatus according to claim 7,
wherein, if at least either sizes or resolutions of the plurality of attribute patterns are different from each other, the attribute setting unit converts at least one of the sizes or the resolutions of the plurality of attribute patterns such that the sizes or the resolutions of the plurality of attribute patterns match.

10. The three-dimensional object data generation apparatus according to claim 1,
wherein the attribute setting unit does not set the attribute for a part of the three-dimensional object outside the attribute pattern.

11. The three-dimensional object data generation apparatus according to claim 1,
wherein the attribute setting unit does not set the attribute or sets a predetermined value for a part of the attribute pattern outside the three-dimensional object.

12. The three-dimensional object data generation apparatus according to claim 1,
wherein the attribute pattern includes a plurality of elements indicating two-dimensional object data, and
wherein the attribute setting unit sets the plurality of elements for at least one of the plurality of voxels as the attribute.

13. The three-dimensional object data generation apparatus according to claim 12,
wherein the attribute setting unit sets, as the attribute, elements of pieces of the two-dimensional object data located at positions corresponding to the plurality of voxels of the three-dimensional object data in accordance with specification of a positional relationship between the three-dimensional object data and the two-dimensional object data.

14. The three-dimensional object data generation apparatus according to claim 12,
wherein the attribute setting unit sets the attribute by copying the elements arranged in two dimensions for the plurality of voxels of the three-dimensional object data.

15. A three-dimensional object forming apparatus comprising:
a forming unit that forms a three-dimensional object on a basis of three-dimensional object data generated by a three-dimensional object data generation apparatus, the three-dimensional object data generation apparatus comprising:
an obtaining unit that obtains three-dimensional object data representing a three-dimensional object with a plurality of voxels;
an attribute pattern reception unit that receives an attribute pattern of an attribute to be set for the plurality of voxels; a setting condition reception unit that receives a setting condition for setting the attribute for the three-dimensional object in accordance with the attribute pattern; and
an attribute setting unit that sets the attribute indicated by the attribute pattern for at least one of the plurality of voxels in accordance with the setting condition.

16. A non-transitory computer readable medium storing a program for generating three-dimensional object data, the program causing a computer to execute a process, the process comprising:
obtaining three-dimensional object data representing a three-dimensional object with a plurality of voxels;
receiving an attribute pattern of an attribute to be set for the plurality of voxels;
receiving a setting condition for setting the attribute for the three-dimensional object in accordance with the attribute pattern; and
setting the attribute indicated by the attribute pattern for at least one of the plurality of voxels in accordance with the setting condition.
